(19) United States
(12) Patent Application Publication
(10) Pub. No.: US 2019/0023590 A1
(43) Pub. Date: Jan. 24, 2019

(54) WATER ACTIVATOR TRANSDUCER

(71) Applicants: Reinerio Linares, Tampa, FL (US); Mauricio Linares Mera, Cali (CO); Juan Carlos Valencia Padilla, Cali (CO); Argemiro Valencia Padilla, Cali (CO); Jose Eliecer Caldono Avila, Cali (CO); Jhon Heiller Martinez Ramos, Cali (CO)

(72) Inventors: Reinerio Linares, Tampa, FL (US); Mauricio Linares Mera, Cali (CO); Juan Carlos Valencia Padilla, Cali (CO); Argemiro Valencia Padilla, Cali (CO); Jose Eliecer Caldono Avila, Cali (CO); Jhon Heiller Martinez Ramos, Cali (CO)

(21) Appl. No.: 16/039,226

(22) Filed: Jul. 18, 2018

Related U.S. Application Data
(60) Provisional application No. 62/534,076, filed on Jul. 18, 2017.

(51) Int. Cl. C02F 1/461; C02F 1/467; C02F 7/00

(52) U.S. Cl. CPC C02F 1/46109; C02F 1/4672; C02F 7/00; B01F 13/0049; C02F 2201/46145; C02F 2201/46165; C02F 2001/46152

(57) ABSTRACT

An apparatus for oxygenating water includes a discharge chamber with a fluid inlet and a fluid outlet, an electronic unit coupled to the discharge chamber, and a power source configured to power the electronic unit. The electronic unit is configured to interact with a fluid disposed within the discharge chamber. The electronic unit is configured to accelerate the fluid and oxygenate the water to produce oxygenated water.

### CROSS-REFERENCE TO RELATED APPLICATIONS

This application claims the benefit of U.S. Provisional Patent Application Ser. No. 62/534,076 filed on Jul. 18, 2017 for Reinerio Linares et al., and entitled “Water Activator Transducer,” the contents of which are hereby incorporated by reference herein.

### FIELD

This invention relates to a water activator transducer and more particularly relates to a portable water activator transducer.

### BACKGROUND

Human activities, agriculture, and other environmental conditions often result in anoxic conditions in bodies or sources of water. Depleted of dissolved oxygen, anoxic groundwater has been defined as water with dissolved oxygen concentration of less than 0.5 milligrams per liter. Water oxygenation is a procedure by which oxygen saturation is increased in water. Human understanding of the positive effects of higher levels of oxygen saturation in water is continuously developing. Hydrogen is an essential element for life, it is present in almost all the molecules in living organisms. Hydrogen gas is seen as the clean fuel of the future.

### SUMMARY

The subject matter of the present application has been developed in response to the present state of the art, and in particular, in response to the problems and disadvantages associated with conventional fixtures that have not yet been fully solved by currently available techniques. Accordingly, the subject matter of the present application has been developed to provide embodiments of a system, an apparatus, and a method that overcome at least some of the above-discussed shortcomings of prior art techniques.

Disclosed herein is an apparatus for oxygenating water. The apparatus for oxygenating water includes a discharge chamber with a fluid inlet and a fluid outlet, an electronic unit coupled to the discharge chamber, and a power source configured to power the electronic unit. The electronic unit is configured to interact with a fluid disposed within the discharge chamber. The electronic unit is configured to accelerate the fluid and oxygenate the water to produce oxygenated water. The preceding subject matter of this paragraph characterizes example 1 of the present disclosure.

The electronic unit includes a cathode and an anode disposed within the discharge chamber and configured to interact with the fluid disposed within the discharge chamber. The preceding subject matter of this paragraph characterizes example 2 of the present disclosure, wherein example 2 also includes the subject matter according to example 1, above.

The electronic unit includes a cathode including a helicoid-shaped electrode of a predetermined length wrapped around an oppositely charged rod. The preceding subject matter of this paragraph characterizes example 3 of the present disclosure, wherein example 3 also includes the subject matter according to any one of examples 1-2, above.

The apparatus for oxygenating water includes a flotation device configured to float on an external water source, wherein the discharge chamber is housed within the flotation device. The preceding subject matter of this paragraph characterizes example 4 of the present disclosure, wherein example 4 also includes the subject matter according to any one of examples 1-3, above.

The flotation device includes a pump configured to intake water into the discharge chamber and a discharge outlet configured to discharge the oxygenated water after the electronic unit has accelerated the water within the discharge chamber. The preceding subject matter of this paragraph characterizes example 5 of the present disclosure, wherein example 5 also includes the subject matter according to any one of examples 1-4, above.

The discharge outlet is configured to discharge the oxygenated water into the external water source and propel the flotation device along a surface of the external water. The preceding subject matter of this paragraph characterizes example 6 of the present disclosure, wherein example 6 also includes the subject matter according to any one of examples 1-5, above.

The apparatus for oxygenating water includes an aerial drone, wherein the discharge chamber is housed within the aerial drone. The preceding subject matter of this paragraph characterizes example 7 of the present disclosure, wherein example 7 also includes the subject matter according to any one of examples 1-6, above.

The power source is a direct current power source. The preceding subject matter of this paragraph characterizes example 8 of the present disclosure, wherein example 8 also includes the subject matter according to any one of examples 1-7, above.

The power source is an alternating current power source. The preceding subject matter of this paragraph characterizes example 9 of the present disclosure, wherein example 9 also includes the subject matter according to any one of examples 1-7, above.

The power source is a plurality of solar panels. The preceding subject matter of this paragraph characterizes example 10 of the present disclosure, wherein example 10 also includes the subject matter according to any one of examples 1-7, above.

The electronic unit is configured to perturb the water to increase the surface area of the water and increase oxygenation. The preceding subject matter of this paragraph characterizes example 11 of the present disclosure, wherein example 11 also includes the subject matter according to any one of examples 1-10, above.

The apparatus is completely submerged in a water source. The preceding subject matter of this paragraph characterizes example 12 of the present disclosure, wherein example 12 also includes the subject matter according to any one of examples 1-11, above.

The apparatus is only partially submerged in a water source to oxygenate the water. The preceding subject matter of this paragraph characterizes example 13 of the present disclosure, wherein example 13 also includes the subject matter according to any one of examples 1-12, above.

The apparatus is coupled to a water tank. The preceding subject matter of this paragraph characterizes example 14 of the present disclosure, wherein example 14 also includes the subject matter according to any one of examples 1-13, above.

The apparatus is coupled to a faucet. The preceding subject matter of this paragraph characterizes example 15 of the present disclosure, wherein example 15 also includes the subject matter according to any one of examples 1-14, above.

The apparatus is coupled to a mobile vehicle, wherein the mobile vehicle includes one of a motor vehicle, a drone, a flying vehicle, or a floating vehicle. The preceding subject matter of this paragraph characterizes example 16 of the present disclosure, wherein example 16 also includes the subject matter according to any one of examples 1-15, above.

Disclosed herein is an apparatus for oxygenating water. The apparatus for oxygenating water includes a discharge chamber with a fluid inlet and a fluid outlet, an electronic unit coupled to the discharge chamber, and a power source configured to power the electronic unit. The electronic unit is configured to interact with a fluid disposed within the discharge chamber. The electronic unit includes a cathode and an anode disposed within the discharge chamber and configured to interact with the fluid disposed within the discharge chamber. The preceding subject matter of this paragraph characterizes example 17 of the present disclosure.

The electronic unit is configured to accelerate the fluid and oxygenate the water to produce oxygenated water. The preceding subject matter of this paragraph characterizes example 18 of the present disclosure, wherein example 18 also includes the subject matter according to example 17, above.

The electronic unit includes a helicoid-shaped electrode of a predetermined length wrapped around an oppositely charged rod. The preceding subject matter of this paragraph characterizes example 19 of the present disclosure, wherein example 19 also includes the subject matter according to any one of examples 17-18, above.

The apparatus further includes a flotation device configured to float on an external water source, wherein the discharge chamber is housed within the flotation device. The flotation device further includes a pump configured to intake water into the discharge chamber. The flotation device further includes a discharge outlet configured to discharge the oxygenated water after the electronic unit has accelerated the water within the discharge chamber. The discharge outlet is configured to discharge the oxygenated water into the external water source and propel the flotation device along a surface of the external water. The preceding subject matter of this paragraph characterizes example 20 of the present disclosure, wherein example 20 also includes the subject matter according to any one of examples 17-19, above.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a perspective view of an apparatus for oxygenating water, according to one or more embodiments of the present disclosure;

FIG. 2 is a perspective view of an apparatus for oxygenating water, according to one or more embodiments of the present disclosure;

FIG. 3 is a partial schematic diagram of an electronic unit, according to one or more embodiments of the present disclosure;

FIG. 4 is a schematic diagram of an electronic unit of an apparatus for oxygenating water, according to one or more embodiments of the present disclosure;

FIG. 5 is a perspective view of an apparatus for oxygenating water and a schematic diagram of the electronic unit, according to one or more embodiments of the present disclosure;

FIG. 6 is a perspective view of a flotation device including an apparatus for oxygenating water, according to one or more embodiments of the present disclosure;

FIG. 7 is a side view of a flotation device including an apparatus for oxygenating water, according to one or more embodiments of the present disclosure;

FIG. 8 is a close-up view of the apparatus for oxygenating water of FIG. 6, according to one or more embodiments of the present disclosure;

FIG. 9 is a schematic diagram of a flotation device including an apparatus for oxygenating water'

FIG. 10 is a side view of a water truck incorporating an apparatus for oxygenating water, according to one or more embodiments of the present disclosure;

FIG. 11 is a schematic diagram of an apparatus for oxygenating water, according to one or more embodiments of the present disclosure; and

FIG. 12 is a schematic diagram of an apparatus for oxygenating water coupled to a water tank, according to one or more embodiments of the present disclosure; and

FIG. 13 is a schematic diagram of a system, according to one or more embodiments of the present disclosure.

### DETAILED DESCRIPTION

The subject matter of the present application has been developed in response to the present state of the art, and in particular, in response to the shortcomings of water oxygenation processes and systems, that have not yet been fully solved by currently available techniques. Accordingly, the subject matter of the present application has been developed to provide an apparatus for oxygenating water, which overcomes at least some of the shortcomings of prior art techniques.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

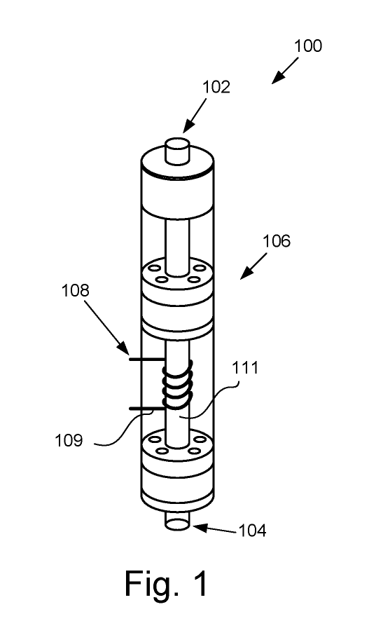

Referring to FIG. 1, a perspective view of an apparatus for oxygenating water 100 is shown. In the illustrated embodiment, the apparatus for oxygenating water 100 is configured to interact with a body of water or water source. The apparatus for oxygenating water 100 includes a water inlet 102 and water outlet 104. Although the apparatus for oxygenating water 100 is shown and described with certain components and functionality, other embodiments of the apparatus for oxygenating water 100 may include fewer or more components to implement less or more functionality.

The apparatus for oxygenating water 100 intakes water from the body of water or water source at the water inlet 102. The apparatus for oxygenating water 100 cycles the water through a discharge chamber 106 which includes an electronic unit 108. After cycling through the discharge chamber and interacting with the electronic unit 108, the water is dispersed out the water outlet 104 and back into the body of water or water source with increased oxygen saturation. In some embodiments, the water flow can be pressurized between 60 and 100 psi.

The apparatus for oxygenating water 100 further includes a power source which provides power to the electronic unit. In some embodiments, the power source is an alternating current power source. In some embodiments, the power source is a direct current power source. The power source may be any combination of conventional power sources for portable devices including batteries or an electrical grid, etc. In some embodiments, the power source may be solar panels or another renewable source.

The apparatus for oxygenating water 100 utilizes the electronic unit to interact with and accelerate the water molecules present in the discharge chamber 106. Within the discharge chamber 106, the water molecules are accelerated to produce oxygen and hydrogen. The excess oxygen increases the oxygen saturation in the remaining water. In some embodiments, as the water in the discharge chamber 106 is accelerated and perturbed, the oxygen interacts with the water at the perturbed water surface to oxygenate the water. In some embodiments, the electronic unit is configured to perturb the water to increase the surface area of the water and increase oxygenation.

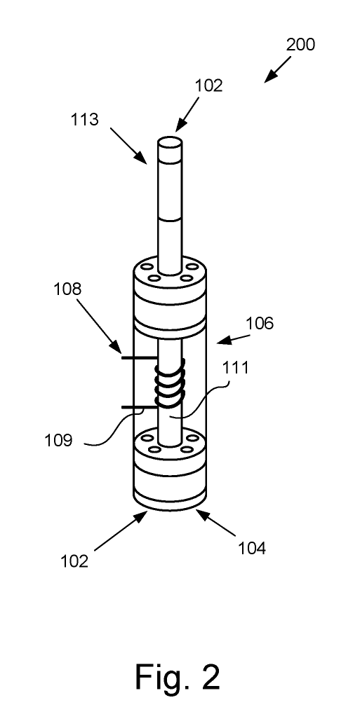

Referring to FIG. 2, a perspective view of an embodiment of a portable apparatus for oxygenating water 200 is shown. The water inlet 102 and water outlet 104 are located on the bottom of the apparatus 200. The discharge chamber 106 or a portion thereof is submerged in water which then intakes water that when cycled through the discharge chamber 106 produces the oxygenated water. In some embodiments, the portable apparatus 200 is configured to be held partially submerged by a handle 115.

The electronic unit 108 includes cell which is submerged in the water within the discharge chamber 106. The cell includes a cathode and an anode. The cathode includes a helicoid-shaped electrode 109 with a predetermined length that surrounds an oppositely charged rod 111 within the discharge chamber.

In some embodiments, application of an algorithm of fragmented codes causes a signal to be generated at the cell and discharged to the water allowing the dissociation and subsequent generation of pico-molecules of oxygen and hydrogen. In addition, within the fragmentation produced by the algorithm is coded information to the water that allows a special molecular reorganization. The discharge has an internal exponential behavior in parameters Kx⁰, where K is a constant. According to the size of the cell, the feeder system of water intake modulates itself to self-adjust. The apparatus 200 is energy efficient in terms of energy consumption. As the work of the apparatus 200 increases, the average energy consumption is lowered.

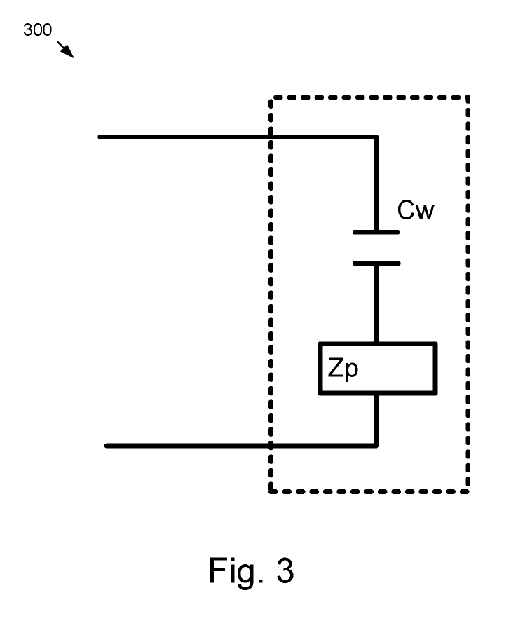

Referring to FIG. 3, a partial schematic diagram 300 of the circuit in the discharge chamber 106 is shown. The discharge chamber 106 is schematically represented by the dashed line 777. As shown in the diagram, C_{w} is calculated as

C_{w}=2πε₀(l/Ln(b/a))

where ε₀=8.8 E 12 f/m

a=inner radius

b=outer radius

l=electrode length

The impedance of the fluid can be determined from the following equation

Zₚ=(Rₚ+X_{g})+X_{w}

where Zₚ=Fluid impedance

Rₚ=Fluid resistance

X_{g}=Fluid reactance

X_{w}=Reactance of wall's capacitance

The discharge chamber 106 has a non-linear behavior since it goes from a high impedance system at t=0 to a low impedance system at t=∞, causing the materials involved in the process to undergo excessive wear and it also causes the transfer of energy to be inefficient, making the water unfit for consumption. The fragmented zero algorithm solves these problems using the decomposition in any number system of zero (0) into twelve PHI codes according to the following series: two open initial codes, two closed packages of four codes, and two final codes, the last one being Base 12 open to induce acceleration, always in packets of 4 endpoint codes through the following quarters after code 12 in the active final quarter. This part of the algorithm is printed on the electrodes defining their shape and structural density and is complemented with energy discharges between the electrodes following the fragmented algorithm of zero in terms of voltage and current.

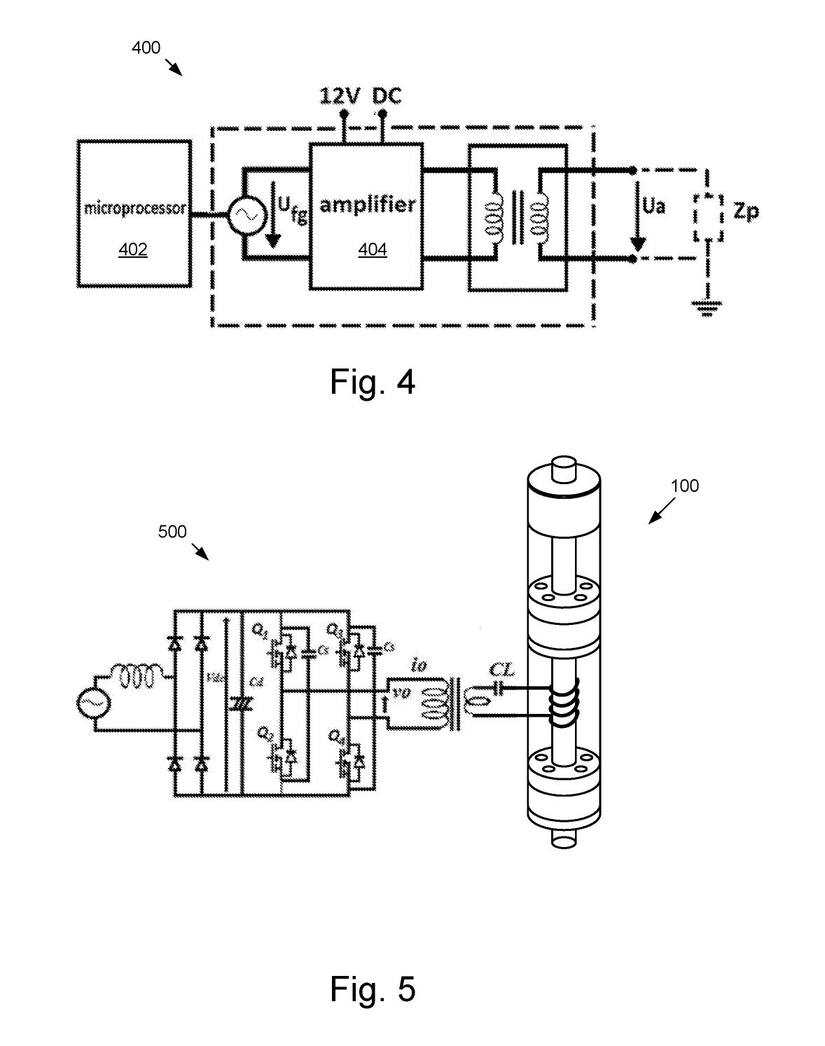

Referring to FIG. 4, a schematic diagram 400 of the electronic unit of an apparatus for oxygenating water is shown. The schematic diagram 400 includes a microprocessor 402, an alternating current voltage source, an amplifier 404, and a transformer. Although the schematic diagram 400 is shown and described with certain components and functionality, other embodiments of the schematic diagram 400 may include fewer or more components to implement less or more functionality. In some embodiments, the electronic unit is configured activate the cathode and the anode within a discharge chamber and/or as is described in conjunction with FIGS. 1 and 2.

Referring to FIG. 5, a perspective view of the apparatus for oxygenating water 100 and a schematic diagram 500 of the electronic unit is shown in more detail. The schematic diagram 500 includes an alternating current voltage source, an inductor, various diodes and capacitors, and a transformer. Although the schematic diagram 500 is shown and described with certain components and functionality, other embodiments of the schematic diagram 500 may include fewer or more components to implement less or more functionality. In some embodiments, the electronic unit is configured activate the cathode and the anode within a discharge chamber as is described in conjunction with FIGS. 1 and 2.

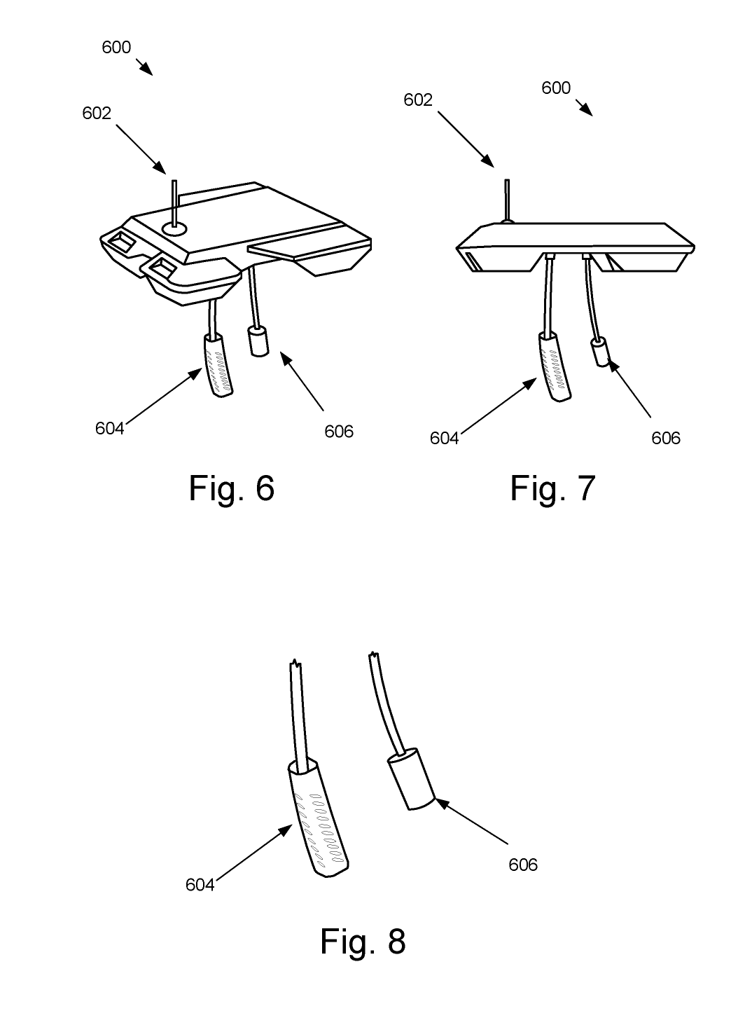

Referring to FIGS. 6-8, a flotation device 600 is shown. Referring to FIG. 6, a perspective view of a flotation device 600 including an apparatus for oxygenating water 604 is shown. The flotation device 600 may be placed on the surface of a large body of water such as a pool, pond, lake, etc. The flotation device 600 includes an antenna 602 that is configured to generate and/or receive a signal from an external source. The signal may direct or control the flotation device 600 to allow for remote operation of the flotation device based on a set of parameters.

The flotation device 600 further includes an apparatus for oxygenating water 604 located on the underside of the flotation device 600 such that the apparatus for oxygenating water 604 is submerged in the water when the flotation device 600 is floating on the surface of the water. The apparatus for oxygenating water 604 may include some or all of the features and provide some or all of the functionality described above in conjunction with the apparatuses 100, 200. In some embodiments, the flotation device 600 could be static or mobile, and could be operated by telemetry. In some embodiments, the flotation device 600 is configured to carry and disperse enzymes and microorganisms to prepare the contaminated water before the oxygenation.

The flotation device 600 further includes a sensor 606 which is also located on the underside of the flotation device 600 such that the sensor 606 is also submerged in the water when the flotation device 600 is floating on the surface of the water.

The sensor 606 may be configured to detect any of a number of characteristics of the water including, but not limited to, the oxygen saturation level of the water. The sensor readings are fed back to the flotation device 600 and a signal may be sent by antenna 602 to provide accurate and up to date readings of the water and optimize the functioning of the apparatus 604. Although the flotation device 600 is shown and described with certain components and functionality, other embodiments of the flotation device 600 may include fewer or more components to implement less or more functionality.

FIG. 7 depicts a side view of the flotation device 600 and FIG. 8 depicts a close-up view of the apparatus for oxygenating water 604 and sensor 606. The flotation device 600 could be built as big as needed, and could have several of the apparatus 604 needed to do oxygenation of larger bodies of waters, (i.e. lakes, ocean bays, etc.) and could be powered by solar, wind, or other source of energy, or could further be operated with an on board staff, such as for large ships.

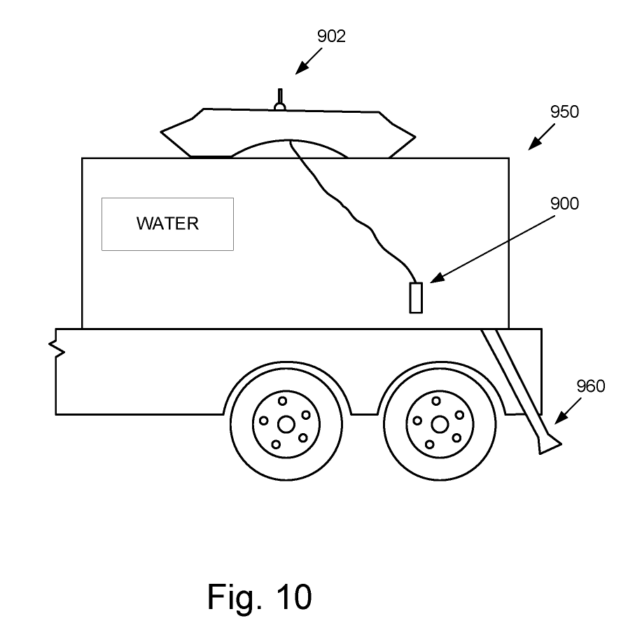

Referring to FIG. 10, a side view of a water truck 950 incorporating an apparatus for oxygenating water 900 is shown. The apparatus 900 may include some or all of the features and provide some or all of the functionality described above in conjunction with the apparatuses 100, 200, 604. The illustrated embodiment further includes a signaling unit 902, including an antenna, which processes, sends, and receives signals to operate and control the apparatus 900 within the water tank of the water truck 950. Although the water truck 950 is shown and described with certain components and functionality, other embodiments of the water truck 950 may include fewer or more components to implement less or more functionality.

Referring to a phi code, the zero (0) fragmented code algorithm is one-, two-, three-, or four-dimensional printout of decomposition in any number system of zero (0) in twelve PHI codes according to the following series: two open initial codes, two closed packets of four codes, and two final codes, the last base 12 being open to induce the acceleration, always in packets of four endpoint codes through the following quarter to the code 12 in the active end quarter, For use in open or closed anode and cathode transducers acting on liquids or gases and in plasma systems. This algorithm allows the device to work with a “Zero” energy delta, it means a cold process, which does not alter the energy potential inherent in the water, allowing it to conserve this release potential or energy transfer potential; (Approximately 2V), (beneficial for living beings).

For printing on metal the algorithm will be run by rotating the codes from the 2 initial codes opened at start and then the next 10 codes of the fragmentation until the code number 12 and passing this, in packages of 4 codes in quarter of the transducer adding the 2 Last codes in any quarter to generate the next code or element of the series according to the numerical system. The algorithm prevents the transducer's fatigue, increases energy efficiency and allows to be printed or configured on the same transducer. The algorithm can be adapted to any programming system that allows controlling the discharge parameter to act on liquids or gases.

The apparatuses described hererin can also be used in the production of hydrogen for energy or different uses, or used bioremediation aquatic drones to decontaminate sewage, lakes, canals and bodies of water in poor conditions, the algorithm must be adjusted to synchronize according to the energy supply, whether photovoltaic, wind or conventional energy and can be adapted to the energy standards of each country.

Many applications are contemplated herein. In some embodiments, the apparatuses described herein are configured to treat drinking water and are used prior to bottling water. In some embodiments, the treated water reduces odor in the feces of barn animals (Roosters and chickens), increases the milk production of milking animals (cows, goats, etc.). Other applications include irrigating crops, soils, compost fields, and contaminated areas. The use of treated water may improve the quality of soil, may improve the growth of crops in the presence of low temperatures or sudden frosts. In some embodiments, the apparatuses described herein may be coupled to portable spraying machines, irrigation systems, planes, or drones. Treated water may function as a bioremediator of soils and mixed with fertilizer produced with fruit and vegetable residues. As described herein, some embodiments of the apparatuses include a plurality of transducers.

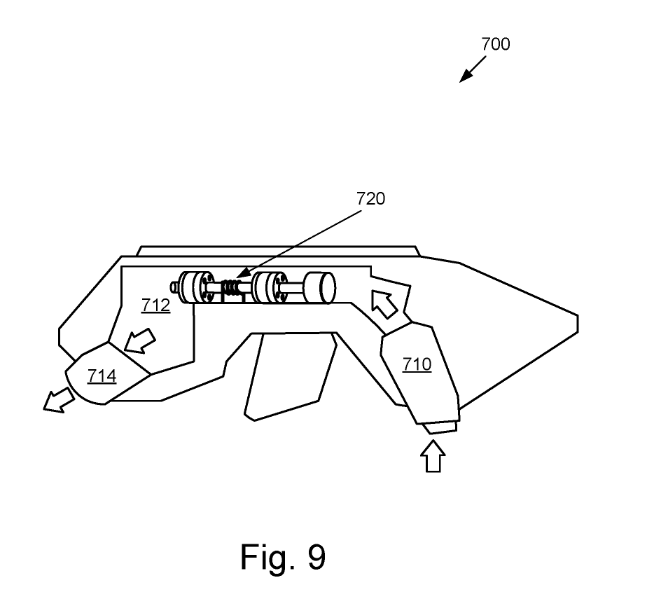

Referring now to FIG. 9, a schematic view of an autonomous flotation device 700 is shown. The autonomous flotation device 700 is made of fiberglass and includes an electronic unit 720 similar to what is described in conjunction with the remaining embodiments described herein. The autonomous flotation device 700 further includes a water suction pump configured to suction water into the autonomous flotation device 700 to interact with the electronic unit 720 and cycled through a chamber 712 housing the electronic unit 720. The treated water is then propelled out a propulsion system 714. In some embodiments, the propulsion system is configured to be adjustable in pressure output and direction, which allows for the control of the floating direction of the autonomous flotation device 700.

The autonomous flotation device 700 allows for the recirculation of a treated water around large lakes of fish hatcheries or pools in the sea for the breeding of shrimp or other fish species.

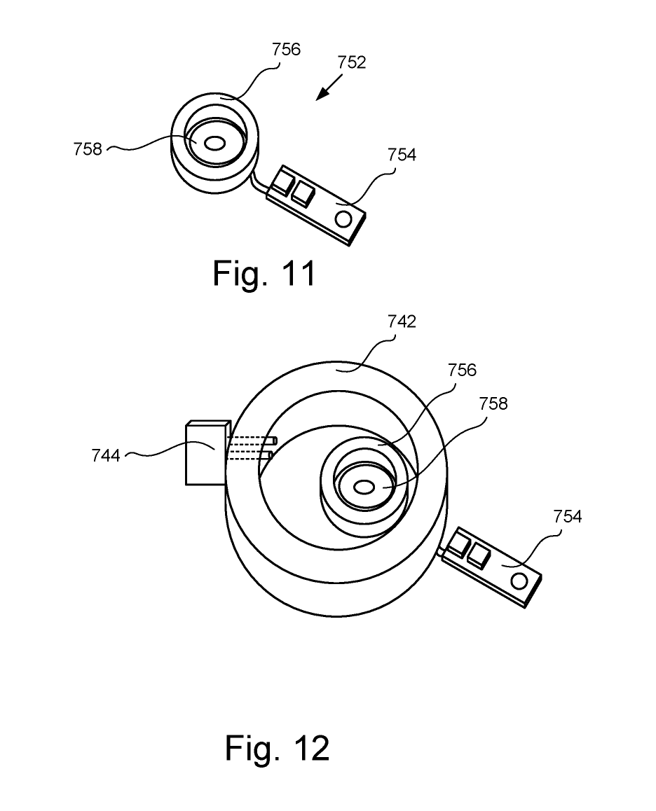

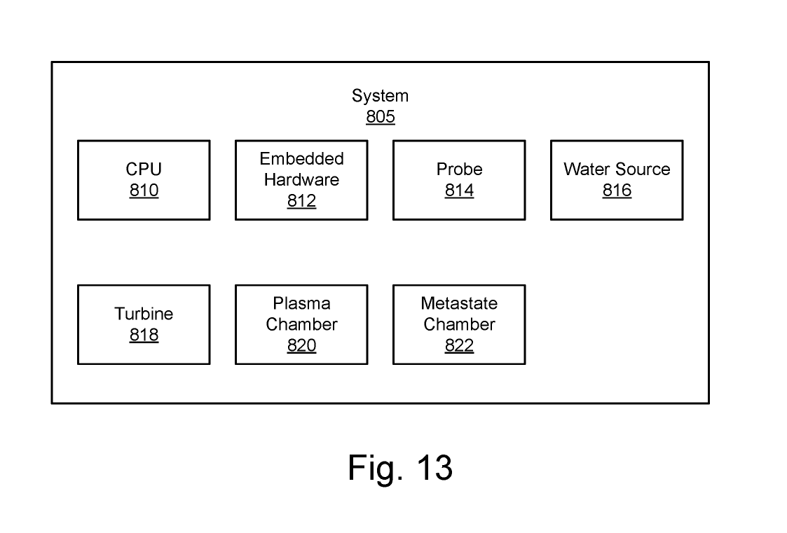

In some embodiments, the apparatuses described herein are configured to reduce mud odors. Referring to FIG. 12, a storage tank (shown in a cut-away view to allow for the apparatus 752 which is also depicted in FIG. 11). The apparatus 752 includes a control unit 754, a chamber 756 (depicted in a cut-away view), and a transducer 758. The apparatus 752 is housed, at least partially, within the storage tank 742. Also coupled to the storage tank 742 is a pump 744 configured to cycle water (or another fluid) through the storage tank 742 to allow for the treatment of the fluid.

In some embodiments, a spray system may be coupled to the storage tank that allows for the spraying of steam or a cloud of treated fluid. Some embodiments reduce COD, chemical oxygen demand, or the total measurement of chemicals in a water source that can be oxidized. Some embodiments reduce BOD, biochemical oxygen demand, or the measured amount of food (or organic carbons) that bacteria can oxidize. Treated water may then be discharged back into the water source.

Some embodiments described herein allow for the interaction of water with industrial oil residue, decreases the degree of contamination of used motor oils, oils used in industrial machinery, facilitates the conversion of these used oils into soluble oils and emulsions. Other applications include interaction with oils and creams for skin care which allows the products to acquire a change in the viscosity, allowing great and quick absorption in the body. The mixture may be used for topical use and works as a cellular restorer in skin burns, wounds, also refreshing eyes drops, makeup cleaner, etc. Other applications include process of conservation and exact maturation of coffee seeds by introducing coffee seeds in treated water in closed containers for periods of thirty, forty five, sixty, and ninety days. In addition to the coffee beans, the liquid byproducts may also be used for gastronomic use among other things. Coffee pulp resulting from the coffee benefit process using treated water. It is used for human consumption or food supplement of farmyard animals. It is offered in presentation of five hundred grams, one thousand grams, five thousand grams or in bulk. It can also be an ingredient for the manufacture of concentrated feed for dogs and cats.

Other applications include home use. In some embodiments, the apparatuses described herein include an optical sensor that can activate the electronic units by movement or proximity. Other types of sensors may also activate the electronic units. Treated water may be used for meat conservation, for improving septic tanks and oxidation ponds, for control of CO₂ emissions in gasoline vehicles and NOₓ in diesel vehicles. Air purification systems may deliver mists of treated water in contaminated areas.

Other applications include using treated water for batteries to increase their durability and improve their efficiency, oil emulsion for wood, improving the extraction of hydrogen in water and improve the quality of hydrogen for use in energy production, bioremediation of lands contaminated with mercury and heavy metals, improvement of air quality through aerial drones, in air improvement applications of cities and crops and to control odor pollution, by gases, carbon dioxide, NOx gases and other gases.

Referring to FIG. 13, a schematic diagram of a system 805 is shown. The system 805 includes a CPU 810, embedded hardware 812, a probe(s) 814, a water source 816, a metastate chamber 822, a plasma chamber 820, and a turbine 818. The apparatuses described herein may be coupled with plasma technology. A first concept is defined as coding has a physical element corresponding to the shape and material of the probe in addition to the signal with which we interact in the water, the signal is composed of the mathematical model developed and running on an embedded CPU this it is complemented with a special hardware designed from the mechanical model of the probe. A second concept refers to bringing water to a meta-state. A third concept is adding the previous concepts to take everything to a plasma chamber 820 where a strong ionization field is generated.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. An apparatus for oxygenating water comprising:
a discharge chamber with a fluid inlet and a fluid outlet;
an electronic unit coupled to the discharge chamber, the electronic unit configured to interact with a fluid disposed within the discharge chamber, wherein the electronic unit is configured to accelerate the fluid and oxygenate the water to produce oxygenated water;
a power source configured to power the electronic unit.

2. The apparatus for oxygenating water according to claim 1, wherein the electronic unit comprises a cathode and an anode disposed within the discharge chamber and configured to interact with the fluid disposed within the discharge chamber.

3. The apparatus for oxygenating water according to claim 1, wherein the electronic unit comprises a cathode comprising a helicoid-shaped electrode of a predetermined length wrapped around an oppositely charged rod.

4. The apparatus for oxygenating water according to claim 1, further comprising a flotation device configured to float on an external water source, wherein the discharge chamber is housed within the flotation device.

5. The apparatus for oxygenating water according to claim 4, wherein flotation device further comprises:
a pump configured to intake water into the discharge chamber; and
a discharge outlet configured to discharge the oxygenated water after the electronic unit has accelerated the water within the discharge chamber.

6. The apparatus for oxygenating water according to claim 5, wherein the discharge outlet is configured to discharge the oxygenated water into the external water source and propel the flotation device along a surface of the external water.

7. The apparatus for oxygenating water according to claim 1, further comprising an aerial drone, wherein the discharge chamber is housed within the aerial drone.

8. The apparatus for oxygenating water according to claim 1, wherein the power source is a direct current power source.

9. The apparatus for oxygenating water according to claim 1, wherein the power source is an alternating current power source.

10. The apparatus for oxygenating water according to claim 1, wherein the power source is a plurality of solar panels.

11. The apparatus for oxygenating water according to claim 1, wherein the electronic unit is configured to perturb the water to increase the surface area of the water and increase oxygenation.

12. The apparatus for oxygenating water according to claim 1, wherein the apparatus is completely submerged in a water source.

13. The apparatus for oxygenating water according to claim 1, wherein the apparatus is only partially submerged in a water source to oxygenate the water.

14. The apparatus for oxygenating water according to claim 1, wherein the apparatus is coupled to a water tank.

15. The apparatus for oxygenating water according to claim 1, wherein the apparatus is coupled to a faucet.

16. The apparatus for oxygenating water according to claim 1, wherein the apparatus is coupled to a mobile vehicle, wherein the mobile vehicle comprises one of a motor vehicle, a drone, a flying vehicle, or a floating vehicle.

17. An apparatus for oxygenating water comprising:
a discharge chamber with a fluid inlet and a fluid outlet;
an electronic unit coupled to the discharge chamber, the electronic unit configured to interact with a fluid disposed within the discharge chamber, wherein the electronic unit comprises a cathode and an anode disposed within the discharge chamber and configured to interact with the fluid disposed within the discharge chamber;
a power source configured to power the electronic unit.

18. The apparatus for oxygenating water according to claim 17, wherein the electronic unit is configured to accelerate the fluid and oxygenate the water to produce oxygenated water.

19. The apparatus for oxygenating water according to claim 17, wherein the electronic unit comprises a cathode comprising a helicoid-shaped electrode of a predetermined length wrapped around an oppositely charged rod.

20. The apparatus for oxygenating water according to claim 17, wherein:
the apparatus further comprises a flotation device configured to float on an external water source, wherein the discharge chamber is housed within the flotation device;
the flotation device further comprises a pump configured to intake water into the discharge chamber; and
the flotation device further comprises a discharge outlet configured to discharge the oxygenated water after the electronic unit has accelerated the water within the discharge chamber; and
the discharge outlet is configured to discharge the oxygenated water into the external water source and propel the flotation device along a surface of the external water.
